(19) United States
(12) Patent Application Publication
(10) Pub. No.: US 2026/0030643 A1
(43) Pub. Date: Jan. 29, 2026

(54) INSIGHT ANALYSIS

(71) Applicant: DevRev, Inc., Palo Alto, CA (US)

(72) Inventors: Gaurav Sharma, Bengaluru (IN); Ankur Vishwakarma, Kanpur (IN); Gaurav Jhamnani, Kanpur (IN); Mahesh Medam, Bengaluru (IN); Saransh Gupta, Bengaluru (IN)

(73) Assignee: DevRev, Inc., Palo Alto, CA (US)

(21) Appl. No.: 18/782,652

(22) Filed: Jul. 24, 2024

(51) Int. Cl. G06Q 30/0201; G06F 40/35; G06F 40/40

(52) U.S. Cl. CPC G06Q 30/0201; G06F 40/35; G06F 40/40

(57) ABSTRACT

Techniques for insight analysis are disclosed relating to a computing device designed to interface with a service platform, having an insight analysis framework capable of executing natural language processing (NLP) and is tasked with receiving sentiment queries and determining an attitude marker that encapsulates user sentiment towards the service platform, based on data from user devices both currently and previously engaged with the platform. The insight analysis framework initiates a preliminary analysis using an interaction analysis framework to evaluate text-based interaction history. The attitude marker is then ascertained by integrating the preliminary analysis results with service analytics and user utility analytics data from respective databases. Finally, the computing device generates a transmission signal to convey the attitude marker to a designated end device, incorporating identification information for accurate delivery.

### BACKGROUND

Service platforms, such as for businesses, organizations, and the like, may be hosted by a device that may perform analyses for comprehending customer attitudes, responses, and requirements while availing or accessing services provided by the service platforms. Understanding customer's interactions, responses, and opinions, i.e., the sentiment towards the service platform is crucial for the growth and improvement of the service platforms that aim to provide services per the requirements of the customers. For instance, the service platform, when accessed by the customer to avail the services, may require the customer to perform various activities or steps. Further, an analysis can be conducted to get an opinion and feedback on the activities that may be performed by the customer on the service platform to avail the services.

### BRIEF DESCRIPTION OF DRAWINGS

The detailed description is described with reference to the accompanying figures. It should be noted that the description and figures are merely examples of the present subject matter and are not meant to represent the subject matter itself.

FIG. 1 illustrates a block diagram of a network architecture for insight analysis, in accordance with an example of the present subject matter.

FIG. 2 illustrates a block diagram of a computing device, according to one example implementation of the present subject matter.

FIG. 3 illustrates a method for insight analysis, according to an example implementation of the present subject matter.

FIG. 4 illustrates a non-transitory computer-readable medium for facilitating insight analysis, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

Understanding user interactions and sentimental responses towards a service platform is vital to provide improved support and services to the users. The service platform can be of a business organization, or any platform that provides services to a user. For service platforms aiming to excel in today's competitive environment, measuring, analyzing, and monitoring user customer sentiment is crucial. In an example, the user may access the service platform. In an example, the user may be the customer engaging and accessing the service platform. For the sake of brevity, the user may be hereinafter interchangeably referred to as the customer. The user may not necessarily be just the customer but may be any entity engaging and accessing the service platform. Such insights help service providers to enhance the service platform, improve the operational efficiency, boost user satisfaction, create superior products and services, and uphold a positive brand reputation. For instance, the service platform is a platform between a developer and a user, and various activities may be performed by the user to avail the services. To understand the attitude of the user towards the service platform, the service platform may conduct surveys and analysis. The service platform herein had been explained as a platform between a developer and a user, however, the service platform may be any business, any organization, user support systems, e-commerce platforms, streaming platform, and the like, and not limited thereto.

Generally, conventional feedback mechanisms are used by the service platforms to conduct surveys and receive responses to preset questionnaires. In one example, the analysis can be conducted online through techniques, while the user may be accessing the service platform. In one example, the analysis can be conducted offline through techniques, such as and not limiting thereto through, pen-paper surveys, telephonic interviews, installation of a physical suggestion box, post-purchase follow-up call, and the like. In such conventional feedback approaches, the user is provided with questionnaires and survey queries enquiring about their recent experiences, opinions, and feedback about the services. Based on the responses provided by the users to the questionnaires and queries, context and emphasis behind the sentiments expressed are observed. The sentiments may be classified in terms of feedback categories, i.e., a positive feedback, a negative feedback, or neutral feedback. The positive feedback is indicative of satisfaction, approval, or appreciation for the service platform. The negative feedback is indicative of dissatisfaction, criticism, and disappointment with the service platform. The neutral feedback is indicative of the user being neither strongly satisfied nor dissatisfied with the service platform.

However, there are certain limitations with respect to conventional feedback mechanisms. For example, the conventional feedback mechanisms are often static and limited in scope as they do not capture real-time interactions or the context of user experiences. The feedback received may be after the user may have accessed or used the service platform. In such an instance, the other users accessing the service platform may face a similar issue since the conventional feedback mechanism may not be accessed and processed and real-time for resolutions. This in turn may lead to operational inefficiencies, recurring failure of user requests, and the like. The conventional feedback mechanisms may be subject to response bias, as the users who respond to such surveys may not represent the broader user profile, leading to skewed results. Additionally, the conventional feedback mechanism may be incapable of performing deep analysis.

Surveys typically do not analyze text-based interactions or unstructured data, which can contain, or provide, rich insights into user sentiment. In addition to the above, it may be difficult to capture real-time interactions because surveys or questionnaires conducted conventionally are often conducted after the user may have interacted with the service platform and this delay can lead to memory bias. Also, by the time feedback is collected and analyzed, the context or circumstances that led to a particular user experience may have changed. Real-time emotions or thoughts that occur during an interaction are often lost when feedback is collected later. Additionally, the conventional feedback mechanisms typically use predetermined questions that may not adapt to the specific context of each user's unique experience. The conventional feedback mechanisms may not consider contextual factors, for instance, external factors that might influence a user's experience (e.g., website load times, concurrent events) are often not captured in conventional feedback mechanisms. These limitations make it challenging to provide a comprehensive, contextual understanding of user's interactions with the platform.

In view of the above, such conventional analysis may neither capture a wide range of interactions and sentiments nor provide comprehensive or significant insights into the requirements of the users for improvement of the service platform. Relying solely on conventional methods of gathering feedback and sentiment assessment through surveys and questionnaires might not capture the full scope of interactions and attitudes. The conventional feedback approaches do not help in gaining a comprehensive understanding of user interactions and experiences with the service platform. Conventional methods, such as surveys and questionnaires, are often reactive and may not capture the full or wide spectrum of user engagement and the nuances of sentiment. The full spectrum in this context is indicative of the comprehensive range of user engagement and sentiment nuances that exist in user interactions with a service platform. Capturing the “full spectrum” indicates gathering and analyzing a complete and diverse set of data points that represent the entirety of user experiences, which may include for instance, but not limited thereto, range of emotions of the users, contextual factors effecting the feedback, reason behind sentiment, temporal aspects that may indicate sentiment changes over time, and the like.

In other words, conventional feedback mechanisms fail to adequately capture and interpret the vast and varied data generated during user interactions with service platforms, which include both structured and unstructured forms of data. Understanding user attitudes and sentiments towards the service platform is a multifaceted challenge that service-oriented businesses typically face.

The present subject matter discloses techniques related to insight analysis. The insight analysis may be performed, for example, for a service platform, by real-time processing and analysis of complex multi-dimensional data. A device may host the service platform. The techniques of the present subject matter, in one example, may accurately assess and predict the attitude response of various segments of users, towards the service platform and enable near real-time detection of changes in sentiment, allowing for prompt actions. In this manner, the present subject matter may allow organizations, businesses, and the like to make informed decisions by providing real-time insights into user's attitudes, identifying trends in user sentiments over time, conducting root-cause analysis to understand underlying factors driving the attitude, generating actionable insights and recommendations for improving the service platform based on comprehensive data analysis, enabling proactive responses to changing user sentiments before they escalate into larger issues, facilitating data-driven decision making by providing quantifiable metrics and attitude markers, and allowing for more personalized and targeted improvements to the service platform based on specific user segments or pain points. This can be done based on a thorough analysis of a user's sentiment and behavior.

The techniques envisaged by the present subject matter may analyze attitude responses in real-time and integrate various metrics and data from disparate sources to provide a comprehensive picture of user engagement and satisfaction. This can, in turn, provide for timely and effective responses to user feedback to allow service platforms to quickly adapt to user sentiments, while integrating data from multiple sources, such as direct interactions, usage metrics, and service-level engagements. The present subject matter facilitates such analysis by providing insights into user sentiments and attitude responses towards the service platform. This proactive approach enables service platforms to identify sentiments, such as identifying trends of the response, performing root cause analysis, and coming up with actionable insights to plan for improving the user feedback.

As an example, the techniques for conducting the insight analysis as disclosed by the present subject matter may be implemented by way of a computing device. The computing device may be in operable communication with a service platform. In an example, the computing device may be in operable communication with a device hosting the service platform. In an example, the computing device may be in operable communication with a device hosting the service platform. The techniques may be implemented by the computing device that may have an advanced learning model capable of performing, for example, natural language processing and implementing the techniques of the insight analysis. In another example, the insight analysis techniques of the present subject matter may be implemented by a third-party service, where the computing device and third-party device(s) may be in communication with one another. In yet another example, the techniques for conducting the insight analysis as disclosed by the present subject matter may be implemented by way of a method. In another example, the techniques of conducting the insight analysis as disclosed by the present subject matter may be implemented by way of a non-transitory computer-readable storage medium storing instructions.

The techniques for insight analysis discern and interprets the attitude response of users towards the service platform. In one example, the insight analysis may be initiated in response to receiving a sentiment query from a device. The sentiment query may be indicative of a request to initiate the analysis of the attitude response regarding the service platform. The attitude response may be an overall sentiment or feelings that users may exhibit towards the service platform. The attitude response may be, for example, positive, negative, or neutral. The attitude response may refer to the overall sentiment or feelings that a user exhibits towards the service platform. The positive attitude response may indicate a favorable or approving sentiment towards the service platform. User with a positive attitude response may generally be satisfied with their experience. The negative attitude response may be indicative of an unfavorable or disapproving sentiment towards the service platform. Users with a negative attitude response may be dissatisfied or frustrated with their experience with the service platform. The neutral attitude response may indicate a balanced or indifferent sentiment towards the service platform. Users with a neutral attitude response may neither be strongly satisfied nor dissatisfied with their experience with the service platform. The sentiment query may be paramount in determining the attitude response that users have towards the service platform, based on their interactions.

In response to the reception of the sentiment query, a preliminary analysis may be conducted. The preliminary analysis may be conducted by, in one example, an interaction analysis framework. In one example, the interaction analysis framework may process engagement data. In one example, the interaction analysis framework may be a Large Language Model (LLM) that may analyze the engagement data. The engagement data, in one example, may include text-based interactions. Examples of the text-based interactions may include, but are not limited to, chat logs, emails, and other forms of communication between the service platform and its users. The interaction analysis framework may parse and evaluate the engagement data to produce a probable result of the preliminary analysis of the attitude response. The advantage of the preliminary analysis is that it provides an initial assessment of the engagement data, which lays the groundwork for a more comprehensive and precise analysis of the attitude response.

Further, an attitude marker may then be determined. The attitude marker, in one example, may be a quantifiable indicator that may reflect the collective attitude response of users towards the service platform. In one example, the attitude marker may be determined based on a service analytics data, user utility analytics data, and results of the preliminary analysis. In one example, the service analytics data, the user utility analytics data, and results of the preliminary analysis may be analyzed and/or processed by an insight analysis framework for determining the attitude marker. The insight analysis framework may include an advanced natural language processing (NLP) model designed to comprehensively analyze user sentiment towards a service platform. It processes various forms of textual data, including chat logs, emails, and support ticket interactions, to extract meaningful insights about user attitudes. The framework employs sophisticated NLP techniques such as sentiment analysis, entity recognition, and contextual understanding to interpret the nuances of language used in user communications. To determine the attitude marker, the insight analysis framework may receive the results of the preliminary analysis of engagement data from the interaction analysis framework, which may be the LLM. The insight analysis framework then integrates this analysis with service analytics data (e.g., problem descriptions, resolution times) and user utility analytics data (e.g., usage metrics, feature preferences) obtained from separate databases, as explained below. The insight analysis framework is to process text-based data and object-based data to determine the attitude marker. The text-based data includes user support interaction data, chat logs, email exchanges, notes and summaries taken during meetings with users and data from phone calls and data from in-person interactions. The object-based data includes user support interaction data, chat logs, email exchanges, notes and summaries taken during meetings with users and data from phone calls and data from in-person interaction.

The engagement data may be procured from various interactions between the service platform and its users and stored in a first database. This data primarily consists of text-based interaction history, including chat logs from customer service interactions, email correspondences, transcripts of phone calls, user feedback submissions, social media comments, and notes from customer meetings. The data is continuously collected as users engage with the service platform through multiple channels, capturing a wide range of user sentiments and experiences. This comprehensive collection of engagement data serves as a crucial input for the interaction analysis framework to conduct its preliminary analysis, providing a foundation for understanding user attitudes and sentiments towards the service platform.

The service analytics data may be stored in the first database and may be derived from service-level interactions with the service platform, and may include information extracted from support ticket interactions, problem descriptions, resolutions, and response times. The user utility analytics data may be stored in a second database and may include usage metrics associated with the service platform and may include at least one of data, such as preferred feature data, duration of usage data, metrics from work management, data derived from customer relationship management (CRM) interfaces, ticket resolution rate, frequency of user/customer interactions, speed of resolving tickets or conversations, and the like. Both types of data provide valuable insights into user's/customer's interactions with and utilization of the service platform, enabling data-driven decision-making for improving user experience and platform functionality.

By synthesizing these diverse data sources, the insight analysis framework calculates a multifaceted attitude marker that may include a final numeric score, trend analysis over time, root cause identification, and actionable recommendations r satisfaction. This comprehensive approach allows the insight analysis framework to capture a holistic view of user sentiment, enabling organizations to make informed decisions and proactively address user needs.

The attitude marker may include, for example, a final attitude score, trend analysis, root cause analysis, and action plan formulation, which indicates or encapsulates the sentiment towards the service platform. Thus, by determining the attitude marker, a measurable representation of the attitude response may be derived or ascertained, which may be employed to identify trends, guide strategic decisions, and enhance the overall user experience. Further, the comprehensive analysis conducted by the disclosed techniques allows generation of actionable insights and strategies to enhance the service platform's response to user attitudes and ensure a dynamic and responsive user experience.

Further, once the attitude marker is determined, a transmission signal may be generated. The transmission signal may convey the attitude marker to an end device. In an example, the end device may be the device that raised the sentiment query. In an example, the end device may be one of the plurality of user devices.

In essence, the techniques for insight analysis as disclosed by the present subject matter offer a holistic and data-centric framework for analyzing the attitude response. By harnessing advanced computational techniques and integrating diverse data sources, the technique provides a potent tool for service platforms to comprehend user attitudes, anticipate trends, and make informed decisions to bolster user satisfaction and engagement.

In view of the above, the present subject matter provides a robust, data-driven framework for insight analysis of attitude responses to a service platform by leveraging advanced computational techniques to deliver actionable insights into user's attitude responses, enabling service platforms to enhance their offerings and user experience. The computing device's architecture, which leverages advanced learning models and databases, is inherently scalable and may handle increasing volumes of data and user interactions, which may be valuable for the betterment, efficiency, and growth of the service platforms, that may eventually lead to rapid expansion in user base.

Further, the present subject matter may be designed to process and analyze data from a variety of sources. Such flexibility means that the techniques of the present subject matter may easily adapt to different types of service platforms and data formats, making it a versatile tool for insight analysis for attitude responses across various platforms, industries, and applications. By processing user interaction data with a controlled and dedicated framework, the techniques of the present subject matter may be designed with robust security measures to protect data and user's privacy. The technique provides real-time insights into user sentiment, thereby allowing fast or instant adjustments to the service platform. The present subject matter provides a significant technical advancement by enabling the service platform to dynamically update and improve based on the comprehensive attitude marker generated by the insight analysis framework. This real-time adaptability allows for swift responses to changing user sentiments and needs, facilitating rapid iterations and enhancements to user experience. The service platform can leverage the attitude marker to make data-driven decisions on feature prioritization, user interface modifications, and service improvements. For instance, if the analysis reveals a negative sentiment trend towards a specific feature, the platform can automatically trigger a review process, allocate resources for improvement, or even temporarily disable problematic elements while solutions are developed. Similarly, positive sentiment trends can inform the platform on which features to expand or replicate across other areas. The insight analysis covers a wide spectrum of user interactions and data points, including text-based communications, service-level analytics, and usage metrics, providing a holistic view that conventional methods often lack. This wide spectrum analysis captures subtle nuances in user sentiment, contextual factors affecting feedback, temporal aspects of sentiment changes, and the underlying reasons behind user attitudes. By covering such a wide spectrum, the system gains a more accurate and nuanced understanding of user experiences, allowing for highly targeted and effective improvements to the service platform. The system can further detect subtle shifts in sentiment, identify emerging trends before they become widespread issues, and correlate user attitudes with specific platform interactions or events. This comprehensive approach enables the platform to identify and address issues that might be overlooked by traditional feedback mechanisms, leading to more personalized user experiences, improved feature development, and enhanced overall service quality. The wide-spectrum analysis translates into a more responsive, user-centric service platform capable of continual refinement and optimization based on deep, data-driven insights into user sentiment and behavior, ultimately allowing the platform to stay ahead of user expectations, adapt to changing needs, and maintain a competitive edge in the market.

The present subject matter reduces the reliance on conventional sentiment approaches that require manual data collection and analysis, which can be time and resource-intensive, and prone to human errors. The present subject matter offers a cost-efficient alternative by minimizing the labor and time associated with conventional sentiment analysis methods. Further, the use of advanced learning models may facilitate deep and semantic analysis, which can discern complex emotional nuances and contextual subtleties in user interactions that simpler analytical tools might miss. Also, the predictive modeling capabilities are technical advantages that allow service platforms to anticipate trends of attitude responses and proactively address potential issues before escalation. For instance, the potential issues may for instance be, but not limited thereto, a gradual decrease in positive sentiment towards specific features or services, emerging user frustrations, certain platform capabilities not being used as intended or expected services or features that are no longer meeting the user requirements, challenges preventing users from fully engaging with new or existing features, and the like.

The present subject matter through the above-mentioned techniques aims to proactively address such and more potential issues before escalations, where the escalations may, for instance, be when there is an increased volume of complaints, users may be leaving the service platform, negative publicity, decreased engagement, service disruptions caused by issues effecting platform functionality, support teams being overburdened with an influx of complaints, and issues leading to reduced revenue or increased costs for the service platform.

This approach of the present subject matter can help in strategic planning and resource allocation. The approach suggested by the present subject matter is a forward-looking approach, since it enables service platforms to anticipate future user needs, and potential issues based on current trends and historical data. Rather than simply reacting to problems as they arise, the present subject matter allows for strategic planning and preemptive improvements to the user's experience. This forward-looking approach can help in strategic planning and resource allocation. The technical solution may be integrated with existing customer relationship management (CRM) systems, support ticketing systems, and other enterprise software, enhancing the value of those systems by providing them with deeper insights into user sentiment.

Further, the advanced learning models may be designed to learn and improve over time to enhance their accuracy and effectiveness in sentiment analysis. This technical advantage ensures that the techniques evolve with the changing dynamics of user interactions and attitude responses. These technical advantages contribute to making the present subject matter a powerful tool for service platforms seeking to understand and improve attitude responses.

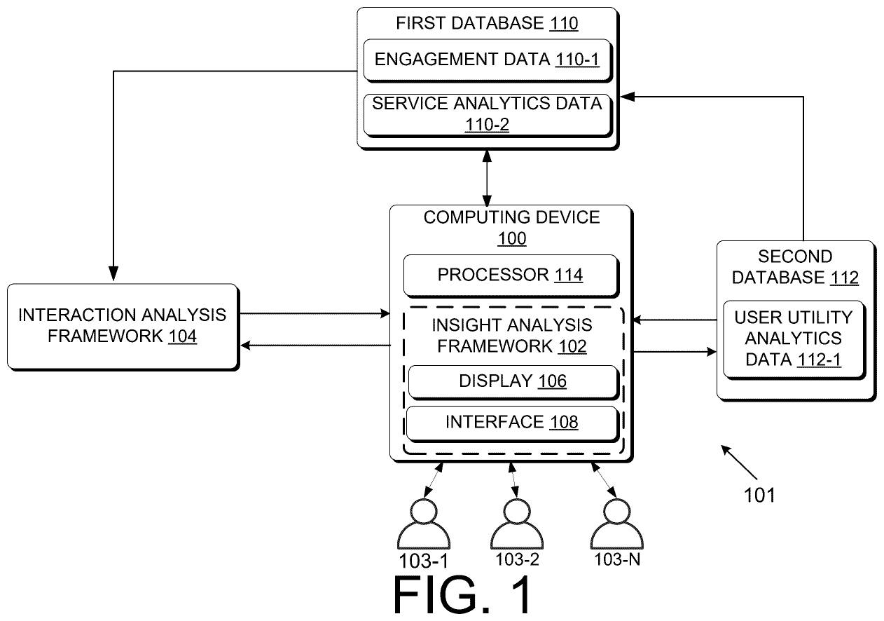

The present subject matter is further described with reference to FIGS. 1-4. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a block diagram of a computing environment 101 for insight analysis, in accordance with an example of the present subject matter. The exemplary computing environment may be, for example, a data center environment, a cloud computing environment, a hybrid environment, an edge computing environment, an internet of things (IOT) environment, a mobile computing environment, and the like.

The computing environment 101 comprises several interconnected components that work together to perform comprehensive insight analysis. The computing environment 101 includes a computing device 100, an interaction analysis framework 104, a first database 110, a second database 112, a plurality of user devices 103-1, 103-2, . . . 103-N.

The computing device 100 includes a processor 114 and the insight analysis framework 102, i.e., an advanced learning model capable of natural language processing for analyzing user sentiment and determining attitude markers. The computing device 100 in operable communication with a device hosting the service platform.

The interaction analysis framework 104, which may be hosted within the computing device 100 or exist as a separate component, conducts preliminary analysis on engagement data using Large Language Models (LLM), providing initial insights into user interactions. The computing device 100 also has an interface 108 playing a crucial role in facilitating seamless communication between the computing device and external entities, including the user devices and databases, ensuring efficient data flow and system integration. A display 106 may be included, connected to the computing device 100, to visually present the results of the sentiment analysis, including attitude markers, trends, and actionable insights.

The first database 110 stores engagement data 110-1, which may include data, such as chat logs and email exchanges. The first database 110 may also store the service analytics data 110-2, which includes data, such as support ticket information and problem resolutions. The second database 112 contains user utility analytics data 112-1, which may include usage metrics, feature preferences, and interaction frequencies. The first database 110 and the second database 112 are collectively referred to as the databases 110, 112 for the sake of brevity. The databases 110, 112 serve as rich repositories of historical and current data essential for in-depth analysis.

The computing environment 101 also incorporates the plurality of user devices 103-1, 103-2, . . . , 103-N, which are the primary sources of user interactions and real-time sentiment data, continuously feeding information into the system. The plurality of user devices may also raise the sentiment query, as will be explained later.

All these components are intricately interconnected through various communication protocols, forming a sophisticated and comprehensive system capable of gathering diverse data, performing multi-layered analysis, and interpreting complex user sentiment patterns to ultimately improve service platform performance and user satisfaction. This has been explained later. In one example, the computing environment 101 may assist in conducting insight analysis to determine an attitude marker that may correspond to a user's attitude response towards the service platform. The attitude marker may be indicative of an attitude response of one or more users towards a service platform. The user may be the customer of the service platform, and the user may be hereinafter interchangeably referred to as the customer. However, the user may not necessarily just be the customer of the service platform but may be any entity that accesses or engages with the service platform to avail its services.

The attitude response may refer to the overall sentiment and emotional reaction that users may have towards the service platform. It encompasses users' feelings, opinions, and behaviors in relation to their interactions with the service platform, which can range from a positive attitude response that is indicative of satisfaction, enthusiasm to negative attitude response that indicates frustration, disappointment, or to a neutral attitude response which indicates remaining neutral. This response may be derived from analyzing various user interactions, feedback, and usage patterns to provide a comprehensive understanding of user perception and experience with the service platform.

To conduct the insight analysis, the computing environment 101 may include multiple components. In one example, the processor 114 may be operably coupled to the insight analysis framework 102 to execute and drive the analysis of the attitude marker towards the service platform.

The computing environment 101 may be implemented in numerous ways, depending on the specific requirements of the service platform. For instance, the computing device 100 may be a server in a data center, a cloud-based service, or an on-premises machine.

The flexibility of the computing environment 101 allows it to adapt to various types of service platforms and data formats, making it a versatile tool for sentiment analysis across different industries and applications. For example, the various types of service platforms may be any business or organization that provides services to the users. The service platform may, for example, but not limited thereto, be a platform for services provided by developers to the customers/users, an e-commerce platform, a social media platform, a customer support system, a streaming service, a financial services platforms, healthcare portals, educational platforms, travel and hospitality services, software-as-a-service (SaaS) platform, as well as different scales of operations from small businesses to large enterprises, and the like. The examples of service platforms are not limited to these examples and may include any business or organization that provides services through a platform.

In an example, the computing device 100, in the context of construction, may be connected to various data sources (not shown) such as project management tools, user/customer feedback systems, and on-site loT sensors. The computing device 100 may aggregate and analyze data from these sources to determine the attitude response of users towards the service platform. As stated above, insight analysis is crucial for service platforms to understand attitude responses in the form of attitude markers and respond to user attitudes effectively. Efficient processing of this analysis is necessary due to the large volumes of data involved and the need for timely insights.

The computing device 100 may process and analyze data to determine an attitude marker associated with the service platform, based on insights, regarding an attitude response towards the service platform, received from a plurality of user devices 103-1, 103-2, . . . 103-N. The insight analysis may be implemented, in one example, in response to a sentiment query being raised for the service platform. The plurality of user devices 103-1, 103-2, . . . 103-N may be any entity that may be capable of raising a query, including the sentiment query. The entity may be, for example, an individual, such as a service platform administrator, or an automated system that may require insight analysis and attitude response into the service platform's serviceability.

The processor 114 within the computing device 100 enables the insight analysis framework 102 to perform its functions effectively, ensuring that sentiment analysis is conducted efficiently and accurately, leading to actionable insights for improving construction project outcomes and stakeholder satisfaction.

The insight analysis framework 102 may be an integral component of the computing device 100, and it may be communicably coupled to all the components of the computing environment 101. The insight analysis framework 102 may include a set of advanced learning models capable of performing natural language processing (NLP) to interpret and analyze interactions between the users and the service platform as well as interactions among users discussing the service platform and may process and evaluate a wide range of data types, including but not limited to, for example, user support interaction data, chat logs, email exchanges, and notes from meetings with users. The insight analysis framework 102 may also handle object-based data, such as metrics from work management systems and customer relationship management (CRM) interfaces.

The insight analysis framework 102 may be operably coupled with the processor 114. In one example, there may be a connection or association between the insight analysis framework 102 and the processor 114 that allows them to functionally interact or communicate with each other. The coupling between the insight analysis framework 102 and the processor 114 may be physical, logical, or both, and enables the transfer of data, signals, or control between the coupled components. Operable coupling between the insight analysis framework 102 and the processor 114 may be direct or indirect and can occur through various means such as wired connections, wireless links, software interfaces, or shared memory. The insight analysis framework 102 and the processor 114 may exchange information or instructions to perform their intended functions in coordination with each other. In an example, the insight analysis framework 102 may be a set of codes configured to conduct the insight analysis. In another example, the insight analysis framework 102 may be a platform that may assist in conducting the insight analysis.

In other words, the insight analysis framework 102 may be operably coupled to the processor 114. The insight analysis framework 102, in one example, may be an advanced learning model capable of performing natural language processing (NLP). The processor 114, in conjunction with other components of the computing device 100, is adapted to conduct insight analysis through the insight analysis framework 102. In one example, the processor 114 may be operably coupled with the insight analysis framework 102 to perform the insight analysis for the service platform. In such an example, the processor 114 may communicate, exchange data, and/or trigger to perform the insight analysis. In another example, the insight analysis may be performed by the insight analysis framework 102 deployed or implemented by the processor 114. In the above examples, the insight analysis framework 102 may be an advanced learning model capable of performing natural language processing and implementing the techniques of the insight analysis. The insight analysis framework 102 may either be communicably coupled with the processor 114 or may be deployed, as a trained model, on the processor 114 itself.

In various implementations, the insight analysis framework 102 may perform functions, such as determining attitude marker which is indicative of attitude response, trend identification, root cause analysis, and the generation of action plans to improve service platform responses. As stated above, attitude response may be indicative of the overall sentiment or feeling users may have towards the service platform based on the experiences and interactions. Further, trend identification involves recognizing patterns in user's attitude/sentiments over time, such as increasing satisfaction with a particular feature or growing frustration with an aspect of the service. Root cause analysis may be conducted to identify the underlying reasons for particular sentiment trends, whether positive or negative.

For example, the insight analysis framework 102 may analyze attitude response to identify issues in service delivery, or it may evaluate a wide range of data to detect patterns indicating issues within services provided by the service platform. This evaluation encompasses key data categories including the engagement data 110-1, service analytics data 110-2 and the user utility analytics data 112. The engagement data may include text-based interaction history between the service platform and users. The service analytics data 110-2, may be derived from service-level interactions such as support ticket information, problem descriptions, resolutions, and response times. Further, the user utility analytics data 112-1 may include usage metrics like preferred feature data, duration of usage, metrics from work management, data derived from customer relationship management (CRM) interfaces, ticket resolution rates, frequency of user interactions, and speed of resolving tickets or conversations. By analyzing this diverse dataset, the insight analysis framework 102 can identify subtle patterns, trends, and anomalies in user behavior, sentiment, and platform performance. This holistic approach allows the framework to pinpoint potential issues in service delivery, user experience gaps, or emerging problems that might not be apparent through conventional analysis methods, enabling the service platform to proactively address concerns and continuously improve its offerings. Additionally, the insight analysis framework 102 may be embedded in a range of devices and systems, such as user/customer service kiosks, project management software, or even mobile applications used by field service technicians, and the like.

The versatility of the insight analysis framework 102 may allow it to be implemented across various sectors, such as being integrated into customer loyalty platforms to understand shopping behaviors and preferences. In each case, the insight analysis framework 102 may leverage computational capabilities to provide deep insights into attitude responses, enabling data-driven decision-making to enhance user experiences and the operational efficiency of the service platform.

The insight analysis framework 102 on receiving a sentiment query may trigger an interaction analysis framework 104, which is another component of the computing environment 101, which works in conjunction with the insight analysis framework 102. The interaction analysis framework 104 may conduct a preliminary analysis of engagement data, which includes the text-based interaction history between the service platform and user devices 103-1, 103-2, . . . 103-N, where N is a natural number. The interaction analysis framework 104 may employ, in one example, one or more large learning models to process and score the engagement data, contributing to the determination of the attitude marker. In other words, the interaction analysis framework 104 may encompass a large-language model that conducts preliminary analysis on engagement data from a first database 110, which includes text-based interaction history, such as chat logs, emails, and notes from various communication channels. The interaction analysis framework 104 may be tasked with parsing and interpreting complex language patterns in the engagement data to generate a result, which serves as the basis for further analysis by the insight analysis framework 102. In an example, the interaction analysis framework 104 may be implemented as an integral part of the computing device 100, communicably coupled with the processor 114 and insight analysis framework 102. Alternatively, it may be deployed or embedded in a component or system that may be separate or external to the computing device 100. The computing device 100 may interact with such separate or external components or system via an interface 108 for preliminary insight analysis. In an example, the insight analysis framework 102 may have a display 106. The display 106 may be a stand-alone screen, a screen integrated with a computing device, and the like capable of displaying the response to the sentiment query. In another example, the interaction analysis framework 104 may be hosted on a cloud-based platform, leveraging distributed processing and scalability, where the computing device 100 communicates with the cloud service to send engagement data and receive analysis results. This implementation flexibility allows the system to be customized to meet the service platform's specific performance, scalability, security, or integration requirements. In one example, the interaction analysis framework 104 may be an integral component and may be responsible for parsing and interpreting the text-based interactions using advanced natural language processing (NLP) techniques. These NLP techniques enable the interaction analysis framework 104 to detect and quantify a preliminary attitude score, which may be indicative of expressions of satisfaction or frustration, colloquial language, and implicit emotional cues. In an example, the interaction analysis framework 104 may also be capable of extending its analysis to engagement data obtained from external sources, such as social media platforms and online review sites, to capture a comprehensive view of user sentiments.

In an example, as illustrated in FIG. 1, the computing environment 101 also includes the first database 110 and a second database 112. The components within the exemplary computing environment 101 are interconnected, facilitating a seamless flow of data and communication. The processor 114, through the insight analysis framework 102, orchestrates the analysis process by directing the interaction analysis framework 104 to perform preliminary analysis. The processor 114 and by integrating the results with data, including service analytics data 110-2 from the first database 110 and user utility analytics data 112-1 from the second database 112 may determine the attitude marker.

The first database 110 is a repository for storing service analytics data, which is derived from service-level interactions with the service platform. This data may include, but is not limited to, support ticket information, problem descriptions, resolutions, and response times. The second database 112 stores user utility analytics data, which comprises usage metrics associated with the service platform, such as feature usage duration and frequency of interactions. The first database 110 and the second database 112 may be realized in various configurations. For example, the first database 110 and the second database 112 may be physical storage devices such as hard drives or solid-state drives that are directly connected to the computing device. This direct connection offers the benefit of swift access to data, which is particularly useful for real-time or near-real-time sentiment analysis tasks. On the other hand, the first database 110 and the second database 112 may be virtual storage units within a cloud storage framework, hosted on remote servers and accessed via the internet or a private network. The virtualized nature of such storage solutions provides scalability and the convenience of accessing data from multiple geographic locations.

In an example, the first database 110 and the second database 112 can be implemented using different data storage technologies, such as relational databases, not only structured query language (NoSQL) databases, or data warehouses, to optimize performance and data management.

In some scenarios, the first database 110 and the second database 112 may be external to the computing device 100, operating as standalone systems that the interface 108 with the computing device 100 through network communications. This separation may be strategically advantageous for enhancing data security, as it allows each database i.e., the first database 110 and the second database 112 to be fortified with specialized security protocols. Moreover, this arrangement can contribute to the robustness of the system, improving disaster recovery and system resilience. Alternatively, the first database 110 and the second database 112 may be integrated within the computing device 100 itself, creating a cohesive system where the storage and processing components are co-located. Such an integrated system can offer performance enhancements due to minimized data access latency and can streamline system administration and maintenance procedures.

In various examples and implementations, the computing device 100 may communicate with user devices via the interface 108, which supports various communication protocols such as Transmission Control Protocol/Internet Protocol (TCP/IP), Hypertext Transfer Protocol (HTTP), Hypertext Transfer Protocol Secure (HTTPS), Bluetooth, Wi-Fi, and cellular networks. These interface 108 ensures secure and efficient data exchange between the computing device, user devices, and databases.

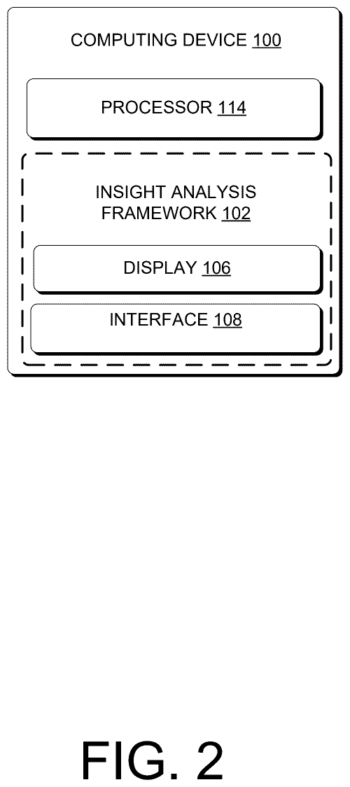

FIG. 2 illustrates a block diagram of the computing device 100, according to one example implementation of the present subject matter. FIG. 2 will be discussed in conjunction with the subject matter discussed above with reference to FIG. 1.

In one example implementation, the computing device 100 may include the processor 114 configured to operate an insight analysis framework 102.

The processor 114 may be a microprocessor, a microcomputer, a microcontroller, a digital signal processor, a central processing unit, a state machine, a logic circuitry, or a device that manipulates signals based on operational instructions. Among other capabilities, the processor 114 may fetch and execute computer-readable instructions stored in a memory (not shown in FIG. 2), such as a volatile memory or a non-volatile memory, of the computing device 100. The functions of the various elements shown in the figure, including any functional blocks labelled as “processor”, may be provided through the use of dedicated hardware as well as hardware capable of executing machine readable instructions.

When provided by the processor 114, the functions may be provided by a single dedicated processor, by a single shared processor, or by a plurality of individual processors, some of which may be shared. Moreover, explicit use of the term “processor” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The memory may be coupled to the processor and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

The interface 108 may include a variety of machine-readable instructions-based interfaces and hardware interfaces that allow the server device to interact with different entities, such as the processor 114. Further, the interface 108 may enable the components of the computing device 100 to communicate with other computing devices, web servers, and external repositories. The interface 108 may facilitate multiple communications within a wide variety of networks and protocol types, including wireless networks, wireless Local Area Network (WLAN), RAN, satellite-based network, and the like.

As an example, the techniques of conducting the insight analysis as disclosed by the present subject matter may be implemented by way of the computing device 100 through the insight analysis framework 102. In another example, the insight analysis framework 102 may be implemented by a third-party service, where the computing device 100 and the third-party service may be in communication with one another through an interface, such as the interface 108. Further, the interface 108 may allow communicably coupling of the computing device 100 and the insight analysis framework 102. The connection or coupling may be through a wired connection or a wireless connection. The interface 108 may also enable intercommunication between the computing device 100 and the insight analysis framework 102. Further, in this example, the computing device 100 may be a computational device or a device capable of performing computing operations and the third-party service may be the advanced learning model capable of performing natural language processing.

According to one example, the insight analysis may be initiated with receipt of a sentiment query. The sentiment query, in one example, may be a request for evaluation and a request for information regarding attitude response towards the service platform. In addition, the sentiment query may also encompass various analytical objectives, such as identifying trends in the attitude response over time, calculating a final attitude score that quantifies sentiment, conducting root cause analysis to uncover the factors influencing user sentiment, and formulating action plans aimed at improving the attitude response. In one example, the attitude response may be the collective emotional and cognitive reaction of users towards the service platform, which may encompass various sentiments, such as satisfaction, frustration, indifference, and the like.

Further, the sentiment query may be instrumental for determining an attitude marker, which is a derived metric that encapsulates insights into the collective sentiment towards the service platform. For instance, the attitude marker may be a quantifiable indicator that represents the overall sentiment or specific aspects of the attitude response, such as positivity or negativity, intensity, and the reasons behind these sentiments. The sentiment query, in one example, may originate from a plurality of user devices, such as the user devices 103-1, 103-2, . . . , and 103-N which may be communicably coupled, either actively or passively, with the service platform or may have previously interacted with the service platform.

In an example, the entity may be able to directly raise the sentiment query. In another example, the entity may trigger or communicate with another computing device to raise the sentiment query on their behalf. In some scenarios, the sentiment query may be automatically generated in response to, or based on, detected patterns in user behavior, such as a sudden increase in the service platform's usage or a drop in the service platform's usage. Such proactive triggering may allow modification or development of the service platform proactively to adapt to user's sentiments and address potential issues in a timely manner.

In one example, upon receiving the sentiment query, the insight analysis framework 102 may trigger an interaction analysis framework 104 to conduct a preliminary analysis of engagement data 110-1. The engagement data 110-1 may be, in one example, text-based interaction history. The text-based interaction history may include, for example, transcripts from user/customer service chats, email correspondences, feedback submissions, and social media comments involving the service platform. The engagement data 110-1 may be rich with sentiment indicators that are indicative of the user's attitudes towards the service platform.

The interaction analysis framework 104 may utilize machine learning to analyze the text-based interactions and compute or assign preliminary attitude scores. The preliminary attitude scores may serve as initial indicators of the attitude response, which may then be used for the determination of the attitude marker.

The interaction analysis framework 104 processes the engagement data 110-1 for preliminary analysis by applying advanced natural language processing techniques to parse and interpret text-based interactions. It extracts sentiment, identifies key themes, recognizes patterns, and considers contextual factors. The framework assigns preliminary sentiment scores to individual interactions, identifies recurring topics, highlights sentiment trends, flags critical issues, and categorizes user feedback. The result of this preliminary analysis includes aggregated sentiment scores, structured theme and pattern data, and a summary report of initial findings. This processed data is then formatted for seamless integration with other data sources by the insight analysis framework 102. The preliminary analysis serves as a crucial first step, providing an initial understanding of user sentiment and key areas of focus, which forms the foundation for the more comprehensive analysis performed by the insight analysis framework 102.

The preliminary analysis conducted by the interaction analysis framework 104 may be a systematic and data-driven process that may establish the foundation for a more detailed insight analysis of attitude responses. By quantifying the text-based interaction history i.e., the engagement data, the interaction analysis framework 104 provides a baseline assessment of user sentiment, which is instrumental in the subsequent determination of the attitude marker. As stated above, the attitude marker is a valuable metric for the service platform's understanding of user attitudes and is central to the techniques for insight analysis disclosed herein.

Following the preliminary analysis conducted by the interaction analysis framework 104, the attitude marker may be determined. The determination of the attitude marker is based on the sentiment query raised and is determined based on the results of the preliminary analysis, a service analytics data 110-2, and a user utility analytics data 112-1.

The service analytics data 110-2 includes information derived from service-level interactions with the service platform. This may encompass details from support ticket interactions, such as problem descriptions, resolutions offered, and response times. Such data provides a quantitative measure of the service platform's performance and user satisfaction levels. Further, the user utility analytics data 112-1, on the other hand, includes usage metrics associated with the service platform. These metrics may include but are not limited to, the duration of usage, frequency of feature utilization, and other relevant analytics that reflect how users engage with the service platform.

The attitude marker is a composite metric that encapsulates the attitude response of the user towards the service platform. The attitude marker is determined by synthesizing the result from the preliminary analysis with the service analytics data 110-2, and the user utility analytics data 112-1. The attitude marker may include, but is not limited thereto, a final attitude score, trends of attitude response over time, identification of the root cause of the sentiment, and an action plan to improve the attitude response.

For instance, the attitude marker may reveal a final attitude score, indicating a shift in user sentiment. The final attitude score may be a quantified representation of the user's sentiment towards the service platform, derived from the analysis of engagement data 110-1, service analytics data 110-2, and user utility analytics data 112-1. The final attitude score is a calculated value that reflects the overall attitude response of users based on their interactions with the service platform. Further, by examining the trend of attitude response, the insight analysis framework 102 may identify that this decrease is part of a longer-term trend of dissatisfaction. Further analysis of the service analytics data 110-2 and user utility analytics data 112-1 may pinpoint the root cause, such as the feature being difficult to use or not meeting user expectations, or the reason for the attitude response. Based on these insights, an action plan can be formulated to address the issues, such as revising the feature or providing additional user support and guidance. By determining the attitude marker as stated above, the present subject matter provides a holistic and data-driven understanding of user sentiment. By integrating diverse data sources, the insight analysis framework 102 can offer a comprehensive view of user attitudes, which is more nuanced and actionable than what could be obtained from a single source of data. This enables service platforms to make informed decisions and take proactive measures to enhance user satisfaction and engagement.

In another exemplary implementation, the attitude marker could be used to inform the development of personalized user experiences. By understanding the specific features or services that correlate with positive sentiment, the service platform can tailor its offerings to better meet the preferences of individual users or user segments.

Overall, the determination of the attitude marker is a sophisticated process that leverages the capabilities of the insight analysis framework 102 to transform raw data into meaningful insights. These insights are invaluable for service platforms seeking to understand and improve their relationship with users, ultimately leading to enhanced service offerings and a more loyal user base. Upon determining the attitude marker, a transmission signal is generated to cause transmission of the attitude marker to an end device. In an example, the end device may be one of the plurality of user devices 103-1, 103-2, . . . , 103-N.

In an example, a communication protocol is initiated to send the attitude marker to the specific user device that may have raised the sentiment query. In another example, the communication protocol is initiated to send the attitude marker to the specific user device that may have been identified to receive it through the interface 108.

The result of transmission may be the successful delivery of the attitude marker to the end device, which may be a smartphone, tablet, laptop, or any other user interface that interacts with the service platform. The end device may then present the attitude marker to the user, enabling them to understand the attitude response. This could manifest as a dashboard display, a notification, or an entry in a report, depending on the implementation.

The attitude markers obtained facilitate immediate and targeted communication of insight analysis by communicating attitude responses through attitude markers. By ensuring that the attitude marker is transmitted directly to the identified end device, service platforms can provide users with real-time insights into attitude response. This timely information allows users to make informed decisions and take prompt actions to address any issues highlighted by the attitude marker.

For example, if the attitude marker indicates a negative sentiment trend, the service platform can quickly engage with the user to address their concerns, potentially improving user satisfaction and loyalty. Conversely, if the attitude marker reflects a positive sentiment, the service platform can acknowledge and reinforce the successful aspects of the user experience.

In summary, the generation and transmission of the attitude marker to an end device is a sophisticated step that leverages communication technology to ensure that sentiment analysis results are promptly and accurately conveyed to the relevant stakeholders. This capability is integral to maintaining a responsive and user-centric service platform.

Therefore, in view of the above features, the computing device 100 provides holistic assessment, real-time insights, and data-driven decision-making. The computing device 100 provides a comprehensive assessment of user sentiment by considering various interactions and metrics. The computing device 100 enables near real-time detection of changes in sentiment, allowing for prompt actions, and also empowers organizations to make informed decisions based on a thorough analysis of user sentiment and behavior.

The present subject matter may, in one example, predict future user sentiments based on historical data and detect and analyze trends over time by assessing the evolution or change in the user sentiment. This can help the service platforms in ensuring that user experiences and service offerings are aligned with the user requirements.

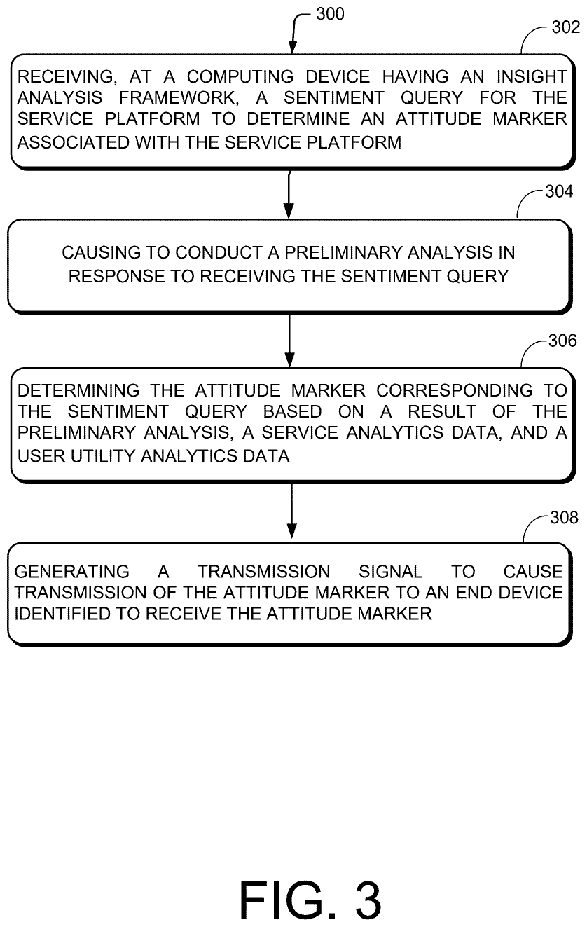

FIG. 3 illustrates a method 300 for insight analysis, according to an example implementation of the present subject matter. The order in which the method 300 is described is not intended to be construed as a limitation, and any number of the described method blocks may be combined in any order to implement the method 300, or an alternative method. Furthermore, the method 300 may be implemented by processor(s) or computing device(s) through any suitable hardware, non-transitory machine-readable instructions, or a combination thereof.

It may be understood that steps of the method 300 may be performed by programmed computing devices and may be executed based on instructions stored in a non-transitory computer-readable medium. The non-transitory computer-readable medium may include, for example, digital memories, magnetic storage media, such as magnetic disks and magnetic tapes, hard drives, or optically readable digital data storage media. The method 300 may be performed by components of the computing environment 101, such as the interaction analysis framework 104, computing device 100, the processor 114, insight analysis framework 102, interface 108, display 106, the first database 110, and the second database 112.

At step 302, at a computing device, a sentiment query for the service platform is received to determine an attitude marker associated with the service platform. The computing device may have an insight analysis framework. The attitude marker may be determined based on insights regarding an attitude response towards the service platform received from a plurality of user devices currently connected or have previously connected with the service platform. The sentiment request may be a request to initiate the analysis of the attitude response regarding the service platform. In this regard, upon receipt of the sentiment query, the insight analysis framework initiates a procedure to ascertain the attitude marker, that is indicative of the attitude response of a user towards the service platform. The attitude response may be an overall sentiment or feelings that users may exhibit towards the service platform, which may be any of positive, negative, or neutral. The computing device may correspond to the computing device 100 and the insight analysis framework may correspond to the insight analysis framework 102. The plurality of user devices may correspond to the plurality of user devices 103-1, 103-2, . . . , 103-N. For instance, in case the service platform is a platform between the developers and customers, the developers, service platform administrators, user support teams, product development team, marketing department, quality assurance team, third-party partners, investors, compliance officers, and the like may initiate a sentiment to initiate the analysis of the attitude response regarding the service platform request for insight analysis.

At step 304, a preliminary analysis in response to receiving the sentiment query is caused to be conducted. The preliminary analysis may be conducted by an interaction analysis framework on an engagement data for the plurality of user devices. The engagement data may include at least one of text-based interaction history between the service platform and one or more of the plurality of user devices. The insight analysis may cause the interaction analysis framework to conduct the preliminary analysis of the engagement data. The interaction analysis framework may be a large-language model. The preliminary analysis may entail parsing text-based interactions to produce a result of the preliminary analysis received from the interaction analysis framework indicative of an initial assessment of attitude response. The interaction analysis framework may correspond to the interaction analysis framework 104. The user devices may correspond to the plurality of user devices 103-1, 103-2, . . . , 103-N.

At step 306, the attitude marker is determined corresponding to the sentiment query based on a result of the preliminary analysis received from the interaction analysis framework, a service analytics data for one or more of the plurality of user devices obtained from a first database, and a user utility analytics data one or more of the plurality of user devices obtained from a second database. The service analytics data may include data derived from service-level interactions with the service platform, and the user utility analytics data comprises usage metrics associated with the service platform. The service analytics data may include service analytics data and user utility analytics data. The service analytics data may include, for example, any of information extracted from support ticket interactions, problem descriptions, resolutions, and response times, and where the user utility analytics data comprises any of preferred feature data, duration of usage data, metrics from work management, and data derived from customer relationship management (CRM) interfaces, ticket resolution rate, frequency of user interactions, and the speed of resolving tickets or conversations, collectively referred to as tickets. In other words, the insight analysis framework may process text-based data and object-based data to determine the attitude marker. The object-based data includes user support interaction data, chat logs, email exchanges, notes and summaries taken during meetings with customers/users and data from phone calls and data from in-person interactions. The determined attitude marker may be one or more of a final numeric score, a trend of the attitude response over a period of time, a root cause of the attitude response, and the action plan to improve the attitude response. The first database corresponds to the first database 110 as discussed in FIG. 1. Similarly, the engagement data corresponds to the engagement data 110-1, the service analytics data corresponds to the service analytics data 110-2, the second database corresponds to the second database 112, and the user utility analytics data corresponds to the user utility analytics data 112-1 as explained in relation to FIG. 1.

Determining the attitude marker includes one of determining a trend of the attitude response over a period of time, determining final numeric score, conducting a root cause analysis of the attitude response, and determining the action plan to improve the attitude response. Determining the trend of the attitude response may include identifying changes in trends of attitude response towards the service platform for a predetermined time period. Determining the final numeric score may be based on an average of numeric scores over the period of time, and the final numeric score is indicative of attitude response. Conducting the root cause analysis of the attitude response may include determining a reason behind the sentiment trends based on the preliminary analysis received from the interaction analysis framework, the service analytics data, and the user utility analytics data. Further, determining the action plan comprises utilizing a determined trend of the attitude response, the final numeric score, and the root cause of the attitude response to determine actions to improve attitude response towards the service platform. In other words, the present subject matter provides a comprehensive approach to enhancing user sentiment towards a service platform. The present subject matter involves analyzing three key components the trend of attitude response over time, a quantitative measure (final numeric score) of overall sentiment, and the underlying reasons (root cause) for user attitudes. By considering these factors together, the system can identify specific areas that need improvement and develop targeted strategies. For example, if the trend shows declining satisfaction, the numeric score is low, and the root cause is identified as poor customer support response times, the action plan might include increasing support staff or implementing more efficient ticketing systems. This data-driven method allows for precise, effective interventions to enhance user experience and satisfaction with the service platform.

At step 308, a transmission signal is generated to cause transmission of the attitude marker to an end device identified to receive the attitude marker, the transmission signal comprising identification information associated with the end device.

Therefore, method 300 provides the entities with uniform data access, periodic performance reporting, and token lifecycle management in a transparent, secure, and reliable manner.

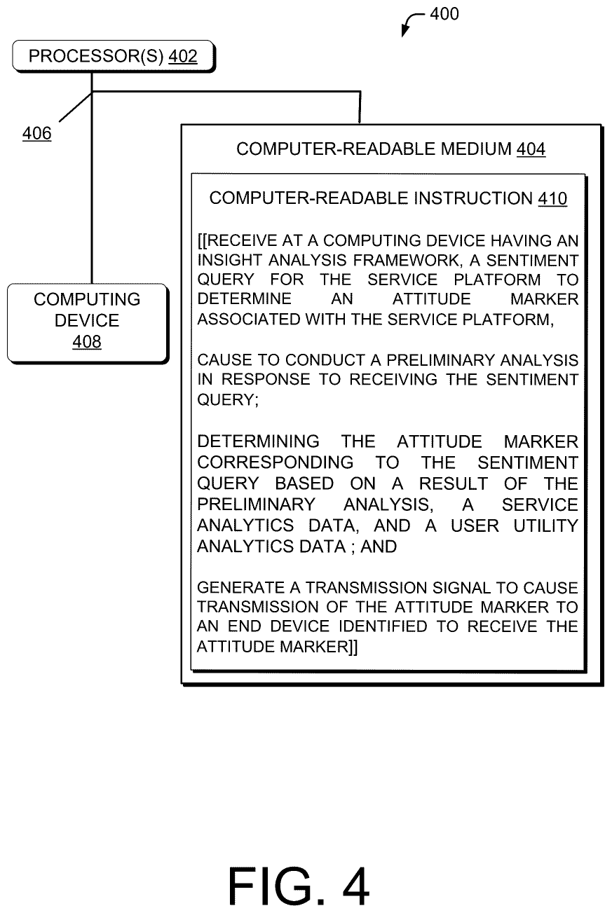

FIG. 4 illustrates a non-transitory computer-readable storage medium for facilitating entity engagement, in accordance with an example of the present subject matter.

In an example, the non-transitory computer-readable storage medium 404 may be utilized by the computing device 408. The computing device 408 may correspond to the computing device 100. The computing device 408 may be implemented in a public networking environment or a private networking environment. In an example, a computing environment 400 may include a processor 402 communicatively coupled to the non-transitory computer-readable storage medium 404 through a communication link 406. the non-transitory computer-readable storage medium 404 is hereinafter interchangeably referred to as the non-transitory computer-readable medium 404 for the sake of brevity. The computing environment 400 may correspond to the computing environment 101.

In an example, the processor 402 may be implemented in a device, such as the computing device 408. The processor 402 may execute the instructions. In other words, the instructions 410 may be executable by the processor 402. The processor 402 may be the processor 114. The non-transitory computer-readable medium 404 may be, for example, an internal memory device of the computing device 408 or an external memory device. In an implementation, the communication link 406 may be a direct communication link, such as any memory read/write interface. In another implementation, the communication link 406 may be an indirect communication link, such as a network interface. In such a case, the processor 402 may access the non-transitory computer-readable medium 404 through a network. The network may be a single network or a combination of multiple networks and may use a variety of different communication protocols. The processor 402 and the non-transitory computer-readable medium 404 may also be communicatively coupled to the computing device 408 over the network.

In an example implementation, the non-transitory computer-readable medium 404 includes a set of computer-readable instructions to perform an action corresponding to insight analysis. The set of computer-readable instructions can be accessed by the processor 402 through the communication link 406 and subsequently executed to perform acts to provide feedback to the actuating object.

Referring to FIG. 4, in an example, the non-transitory computer-readable medium 404 includes instructions 410.

Referring to FIG. 4, in an example, the non-transitory computer-readable medium 404 includes instructions 410 that when executed cause the processor 402 to receive an onboarding request from an interested entity. The interested entity could be various stakeholders engaging with the service platform. The interested entity may be for instance, but not limited thereto, customers, service platform administrators, automated systems, developers, customer support teams, product development teams, marketing departments, quality assurance teams, third-party partners, investors, and the like. The interested entity may initiate the sentiment request to access insight analysis capabilities, understand user sentiment, or contribute to improving the platform's services. The request may be the interested entities' intention to establish a formal relationship with the service platform, enabling them to leverage the attitude responses and analytics provided by the system for their specific needs, whether it's enhancing user experience, refining services, or making informed business decisions. In an example, the interested entity may be one of the plurality of user devices 103-1, 103-2, . . . , 103-N. The onboarding request is indicative of an intention to create an engagement with an entity of interest. The entity of interest may be the service platform, that may provide services to users, and about which the interested entity seeks to gain insights or engage with. The service platform could be of any business, organization, user/customer support system, e-commerce platform, streaming service, or other digital service that interacts with users. The entity of interest is the focus of the sentiment analysis and attitude response measurements conducted by the insight analysis framework. It is the subject of the engagement data, service analytics data, and user utility analytics data that are analyzed to determine the attitude marker. By creating an engagement with this entity of interest, the interested entity aims to understand, interact with, or contribute to the service platform's operations, user experience, or overall performance.

The instructions 410, when executed, may further cause the processor 402 to generate a first profile for the interested entity. The first profile includes a first plurality of attributes, a first plurality of attribute values associated with each of the first plurality of attributes, and a first unique identifier associated with the first profile to identify the interested entity.

Further, the instructions 410, when executed, may cause the processor 402 to receive at a computing device 100 having an insight analysis framework, such as the insight analysis framework 102, a sentiment query for the service platform to determine an attitude marker associated with the service platform. The attitude marker may be determined based on insights regarding an attitude response towards the service platform received from a plurality of user devices currently connected or have previously connected with the service platform. The computing device, such as the computing device 100, and the insight analysis framework, such as the insight analysis framework 102. For instance, in case the service platform is a platform between the developers and customers, the developers, service platform administrators, user/customer support teams, product development team, marketing department, quality assurance team, third-party partners, investors, compliance officers, and the like may initiate a sentiment to initiate the analysis of the attitude response regarding the service platform request for insight analysis.

The instructions 410, when executed, may cause the processor 402 to conduct a preliminary analysis in response to receiving the sentiment query. The preliminary analysis is conducted by an interaction analysis framework, such as the interaction analysis framework 104, on engagement data for the plurality of user devices. The engagement data is procured from various interactions between the service platform and its users. The engagement data comprises at least one of text-based interaction history between the service platform and one or more of the plurality of user devices. The interaction analysis framework, such as the interaction analysis framework 104. The plurality of user devices, such as the plurality of user devices 103-1, 103-2, . . . 103-N. The instructions 410, when executed, may cause the processor 402 to cause the interaction analysis framework 104 to conduct the preliminary analysis on the engagement data, where the interaction analysis framework 104, in one example, is the LLM. The instructions direct the processor to initiate a preliminary analysis in response to receiving the sentiment query. This analysis is conducted by the interaction analysis framework 104, which employs the LLM to process engagement data. The engagement data, procured from various interactions between the service platform and users via plurality of user devices 103-1, 103-2, . . . , 103-N, predominantly comprises text-based interaction history. The processor instructs the interaction analysis framework 104 to perform the preliminary analysis on this engagement data, leveraging its LLM capabilities. This process involves parsing and interpreting the text-based interactions to extract initial insights about user sentiments, establishing a foundation for the subsequent comprehensive analysis of attitude responses. The preliminary analysis provides a broader insight analysis process, efficiently processing large volumes of textual data to identify patterns and sentiments in user interactions with the service platform.

The instructions 410, when executed, may also cause the processor 402, in one example, to determine the attitude marker corresponding to the sentiment query based on a result of the preliminary analysis received from the interaction analysis framework, a service analytics data for one or more of the plurality of user devices obtained from a first database, and a user utility analytics data one or more of the plurality of user devices obtained from a second database, as explained with respect to FIGS. 1 and 2. The service analytics data includes data derived from service-level interactions with the service platform, and the user utility analytics data includes usage metrics associated with the service platform. The determined attitude marker may be one or more of a final numeric score, a trend of the attitude response over a period of time, a root cause of the attitude response, and the action plan to improve the attitude response. The instructions 410, when executed, may cause the processor 402 to determine the attitude marker including one of determining a trend of the attitude response over a period of time, determining final numeric score, conducting a root cause analysis of the attitude response, determining the action plan to improve the attitude response. The instructions 410, when executed, may cause the processor 402 to determine the trend of the attitude response which may include identifying changes in trends of attitude response towards the service platform for a predetermined time period. The instructions 410, when executed, may cause the processor 402 to determine the final numeric score which may be based on an average of numeric scores over the period of time, and the final numeric score is indicative of attitude response. The instructions 410, when executed, may cause the processor 402 to conduct the root cause analysis of the attitude response. The instructions 410, when executed, may cause the processor 402 to determine a reason behind the sentiment trends based on the preliminary analysis received from the interaction analysis framework, the service analytics data, and the user utility analytics data. Further, the instructions 410, when executed, may cause the processor 402 to determine the action plan. The instructions 410, when executed after determining the action plan, may cause the processor 402 to utilize the determined trend of the attitude response, the final numeric score, and the root cause of the attitude response to determine actions to improve attitude response towards the service platform. The instructions direct the processor to determine the attitude marker by synthesizing data from multiple sources: the preliminary analysis results, service analytics data, and user utility analytics data. This comprehensive process encompasses several key steps: analyzing temporal trends in attitude responses, calculating quantitative sentiment scores, conducting root cause analysis to identify underlying factors influencing user sentiment, and formulating strategic action plans for sentiment improvement. The resulting attitude marker is a multifaceted metric that may include a final numeric score, trend analysis over a specified time period, identification of root causes, and recommended actions. This sophisticated approach enables the service platform to gain nuanced insights into user sentiments, facilitating data-driven decision-making to enhance user experience and optimize platform performance. The processor executes these analytical tasks systematically, leveraging various data inputs to produce a holistic representation of user attitudes toward the service platform. The first database, such as the first database 110, and the second database, such as the second database 112.

The instructions 410, when executed, may cause the processor 402 to generate a transmission signal to cause transmission of the attitude marker to an end device identified to receive the attitude marker. The transmission signal comprises identification information associated with the end device. The instructions direct the processor to create a transmission signal containing the attitude marker and identification information for ta specific end device. This signal is then sent to the identified end device, ensuring the attitude marker is delivered to the correct recipient for further action or analysis. The end device may be the device that had raised the sentiment query. In an example, the end device may be a display, such as the display 106. In another example, the end may be one of the plurality of user devices, such as the plurality of user devices 103-1, 103-2, . . . , 103-N.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A computing device in operable communication with a device hosting a service platform, the computing device comprising:
a processor;
an insight analysis framework, operably coupled to the processor, being an advanced learning model capable of performing natural language processing (NLP), wherein the insight analysis framework is to:
receive a sentiment query for a service platform to determine an attitude marker associated with the service platform, wherein the attitude marker is to be determined based on insights regarding an attitude response towards the service platform received from a plurality of user devices currently connected or have previously connected with the service platform;
cause conducting of a preliminary analysis in response to receiving the sentiment query, wherein the preliminary analysis is conducted by an interaction analysis framework on an engagement data for the plurality of user devices, wherein the engagement data comprises a text-based interaction history between the service platform and one or more of the plurality of user devices;
determine the attitude marker corresponding to the sentiment query based on a result of the preliminary analysis received from the interaction analysis framework, a service analytics data for one or more of the plurality of user devices obtained from a first database, and a user utility analytics data for one or more of the plurality of user devices obtained from a second database, wherein the service analytics data comprises data derived from service-level interactions with the service platform, and the user utility analytics data comprises usage metrics associated with the service platform; and
generate a transmission signal to cause transmission of the attitude marker to an end device identified to receive the attitude marker, the transmission signal comprising identification information associated with the end device.

2. The computing device of claim 1, wherein the attitude marker is one or more of a final numeric score, a trend of the attitude response over a period of time, a root cause analysis of the attitude response, and an action plan to improve the attitude response.

3. The computing device of claim 1, wherein the sentiment query comprises one of determining a trend of the attitude response over a period of time, determining a final numeric score, conducting a root cause analysis of the attitude response, determining an action plan to improve the attitude response,
wherein determining the trend of the attitude response, comprises identifying changes in trends of attitude response towards the service platform over the period of time,
determining the final numeric score is based on an average of numeric scores over the period of time, and the final numeric score is indicative of attitude response,
conducting the root cause analysis of the attitude response comprises to determine a reason behind sentiment trends based on the preliminary analysis received from the interaction analysis framework, the service analytics data, and the user utility analytics data, and
determining an action plan comprises utilizing a determined trend of the attitude response, the final numeric score and the root cause of the attitude response to determine actions to improve attitude response towards the service platform.

4. The computing device of claim 1, wherein the insight analysis framework is to cause the interaction analysis framework to conduct the preliminary analysis on the engagement data, wherein the interaction analysis framework is a large-language model.

5. The computing device of claim 1, wherein the insight analysis framework is to process a text-based data and an object-based data to determine the attitude marker, the text-based data comprising user support interaction data, chat logs, email exchanges, notes and summaries taken during meetings with users and data from phone calls and data from in-person interactions, and the object-based data comprising user support interaction data, chat logs, email exchanges, notes and summaries taken during meetings with users and data from phone calls and data from in-person interactions.

6. The computing device of claim 1, wherein the service analytics data comprises at least one of information extracted from support ticket interactions, problem descriptions, resolutions, and response times.

7. The computing device of claim 1, wherein the user utility analytics data comprises any of preferred feature data, duration of usage data, metrics from work management, data derived from customer relationship management (CRM) interfaces, ticket resolution rate, frequency of user interactions, and a speed of resolving tickets.

8. A method for insight analysis, the method comprising:
receiving, at a computing device having an insight analysis framework, a sentiment query for a service platform to determine an attitude marker associated with the service platform, wherein the attitude marker is to be determined based on insights regarding an attitude response towards the service platform received from a plurality of user devices currently connected or have previously connected with the service platform;
causing to conduct a preliminary analysis in response to receiving the sentiment query, wherein the preliminary analysis is conducted by an interaction analysis framework on an engagement data for the plurality of user devices, wherein the engagement data comprises a text-based interaction history between the service platform and one or more of the plurality of user devices;
determining the attitude marker corresponding to the sentiment query based on a result of the preliminary analysis received from the interaction analysis framework, a service analytics data for one or more of the plurality of user devices obtained from a first database, and a user utility analytics data for one or more of the plurality of user devices obtained from a second database, wherein the service analytics data comprises data derived from service-level interactions with the service platform, and the user utility analytics data comprises usage metrics associated with the service platform; and
generating a transmission signal to cause transmission of the attitude marker to an end device identified to receive the attitude marker, the transmission signal comprising identification information associated with the end device.

9. The method of claim 8, wherein the attitude marker is one or more of a final numeric score, a trend of the attitude response over a period of time, a root cause analysis of the attitude response, and an action plan to improve the attitude response.

10. The method of claim 8, wherein the sentiment query comprises one of determining a trend of the attitude response over a period of time, determining a final numeric score, conducting a root cause analysis of the attitude response, determining an action plan to improve the attitude response,
wherein determining the trend of the attitude response, comprises identifying changes in trends of attitude response towards the service platform for the period of time,
determining the final numeric score is based on an average of numeric scores over the period of time, and the final numeric score is indicative of attitude response,
conducting the root cause analysis of the attitude response comprises determining a reason behind sentiment trends based on the preliminary analysis received from the interaction analysis framework, the service analytics data, and the user utility analytics data, and
determining an action plan comprises utilizing a determined trend of the attitude response, the final numeric score and the root cause of the attitude response to determine actions to improve attitude response towards the service platform.

11. The method of claim 8, wherein the insight analysis framework is to cause the interaction analysis framework to conduct the preliminary analysis on the engagement data, wherein the interaction analysis framework is a large-language model.

12. The method of claim 8, wherein the insight analysis framework is to process a text-based data and an object-based data to determine the attitude marker, wherein the text-based data comprising user support interaction data, chat logs, email exchanges, notes and summaries taken during meetings with users and data from phone calls and data from in-person interactions, and the object-based data comprising user support interaction data, chat logs, email exchanges, notes and summaries taken during meetings with users and data from phone calls and data from in-person interactions.

13. The method of claim 8, wherein the service analytics data comprises at least one of information extracted from support ticket interactions, problem descriptions, resolutions, and response times.

14. The method of claim 8, wherein the user utility analytics data comprises any of preferred feature data, duration of usage data, metrics from work management, data derived from customer relationship management (CRM) interfaces, ticket resolution rate, frequency of user interactions, and a speed of resolving tickets.

15. A non-transitory computer-readable storage medium storing instructions for insight analysis, the instructions being executable by a processor to:
receive, at a computing device having an insight analysis framework, a sentiment query for a service platform to determine an attitude marker associated with the service platform, wherein the attitude marker is to be determined based on insights regarding an attitude response towards the service platform received from a plurality of user devices currently connected or have previously connected with the service platform;
cause to conduct a preliminary analysis in response to receiving the sentiment query, wherein the preliminary analysis is conducted by an interaction analysis framework on an engagement data for the plurality of user devices, wherein the engagement data comprises a text-based interaction history between the service platform and one or more of the plurality of user devices;
determine the attitude marker corresponding to the sentiment query based on a result of the preliminary analysis received from the interaction analysis framework, a service analytics data for one or more of the plurality of user devices obtained from a first database, and a user utility analytics data for one or more of the plurality of user devices obtained from a second database, wherein the service analytics data comprises data derived from service-level interactions with the service platform, and the user utility analytics data comprises usage metrics associated with the service platform; and
generate a transmission signal to cause transmission of the attitude marker to an end device identified to receive the attitude marker, the transmission signal comprising identification information associated with the end device.

16. The non-transitory computer-readable storage medium of claim 15, wherein the instructions are executable by a processor to cause the interaction analysis framework to conduct the preliminary analysis on the engagement data, wherein the interaction analysis framework is a large-language model.

17. The non-transitory computer-readable storage medium of claim 15, wherein the instructions are executable by a processor to:
determine one of a trend of the attitude response over a period of time and a final numeric score;
conduct a root cause analysis of the attitude response; and
determine an action plan to improve the attitude response,
wherein determining the trend of the attitude response, comprises identifying changes in trends of attitude response towards the service platform for the period of time,
determining the final numeric score is based on an average of numeric scores over the period of time, and the final numeric score is indicative of attitude response,
conducting the root cause analysis of the attitude response comprises determining a reason behind sentiment trends based on the preliminary analysis received from the interaction analysis framework, the service analytics data, and the user utility analytics data, and
determining an action plan comprises utilizing a determined trend of the attitude response, the final numeric score and the root cause of the attitude response to determine actions to improve attitude response towards the service platform.

18. The non-transitory computer-readable storage medium of claim 15, wherein the attitude marker is one or more of a final numeric score, a trend of the attitude response over a period of time, a root cause analysis of the attitude response, and an action plan to improve the attitude response.

19. The non-transitory computer-readable storage medium of claim 15, wherein the insight analysis framework is to process a text-based data and an object-based data to determine the attitude marker, wherein the text-based data comprising user support interaction data, chat logs, email exchanges, notes and summaries taken during meetings with users and data from phone calls and data from in-person interactions, and the object-based data comprising user support interaction data, chat logs, email exchanges, notes and summaries taken during meetings with users and data from phone calls and data from in-person interactions.

20. The non-transitory computer-readable storage medium of claim 15, wherein the service analytics data comprises any of information extracted from support ticket interactions, problem descriptions, resolutions, and response times and wherein the user utility analytics data comprises any of preferred feature data, duration of usage data, metrics from work management, data derived from customer relationship management (CRM) interfaces, ticket resolution rate, frequency of user interactions, and a speed of resolving tickets.
